(19) United States
(12) Patent Application Publication
(10) Pub. No.: US 2003/0117343 A1
(43) Pub. Date: Jun. 26, 2003

(54) Mobile computer with an integrated micro projection display

(76) Inventor: Ralph M. Kling, Sunnyvale, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/022,468

(22) Filed: Dec. 14, 2001

(51) Int. Cl. G09G 3/00

(52) U.S. Cl. 345/32

(57) ABSTRACT

A mobile computer with an integrated micro projection display. The apparatus of one embodiment comprises a computing subsystem to process data and execute program instructions. An optical subsystem is coupled to the computing subsystem. The optical subsystem is integrated into the apparatus to project an image for the computing subsystem onto a viewing surface.

### FIELD OF THE INVENTION

The present invention relates generally to the field of computer systems. More particularly, the present invention relates to a method for a mobile computer with an integrated micro projection display.

### BACKGROUND OF THE INVENTION

Computer systems have become increasingly pervasive in our society. The processing capabilities of computers have increased the efficiency and productivity of workers in a wide spectrum of professions. As the costs of purchasing and owning a computer continues to drop, more and more consumers have been able to take advantage of newer and faster machines. Furthermore, many people enjoy the use of notebook computers because of the freedom. Mobile computers allow users to easily transport their data and work with them as they leave the office or travel. This scenario is quite familiar with marketing staff, corporate executives, and even students.

As people work outside of their traditional office, they often find themselves sharing their data or making presentations. However, display technology for mobile computers has lagged behind that for desktop machines. The present mobile display screens are generally difficult to view by anyone other than the sole user sitting directly in front of the display. FIG. 1A is an illustration of a typical prior art mobile computer system 102. Mobile computer 102 has a single flat display screen that can be positioned for viewing by a single user. Even with multiple screen adjustments, viewing what is on the screen can be somewhat of a chore. Someone trying to look at the display from an angle may not be able to see what is illustrated.

But if the user is trying to share information displayed on the screen, there may be times when numerous pairs of eyes are trying to view the same display screen. Some users have resorted to other types of displays. FIG. 1B is an illustration of another prior art mobile computer system 150. Mobile computer 152 is connected to a desktop computer monitor 154. The computer 152 is also connected to a large external projection system 156 to project images on a movie screen 158. All this extra computer equipment is necessary in order to share the graphical data of a mobile computer. Thus the sharing of visual information in existing prior art systems is very cumbersome.

### BRIEF DESCRIPTION OF THE DRAWINGS

The present invention is illustrated by way of example and not limitations in the figures of the accompanying drawings, in which like references indicate similar elements, and in which:

FIG. 1A is an illustration of a typical prior art mobile computer system;

FIG. 1B is an illustration of another prior art mobile computer system;

FIG. 2 is an illustration of a mobile computer system with an integrated micro projection display in accordance with one embodiment of the present invention;

FIG. 3A is an illustration of another embodiment of a mobile computer having a micro projection display in an easy-to-carry shape;

FIG. 3B is a block diagram of the innards for the base unit of FIG. 2 or 3A;

FIG. 3C is a block diagram of the computing subsystem of FIG. 3B; and

FIG. 4 is a flow diagram showing one embodiment of a method for a mobile computer system with an integrated micro projection display in accordance with the present invention.

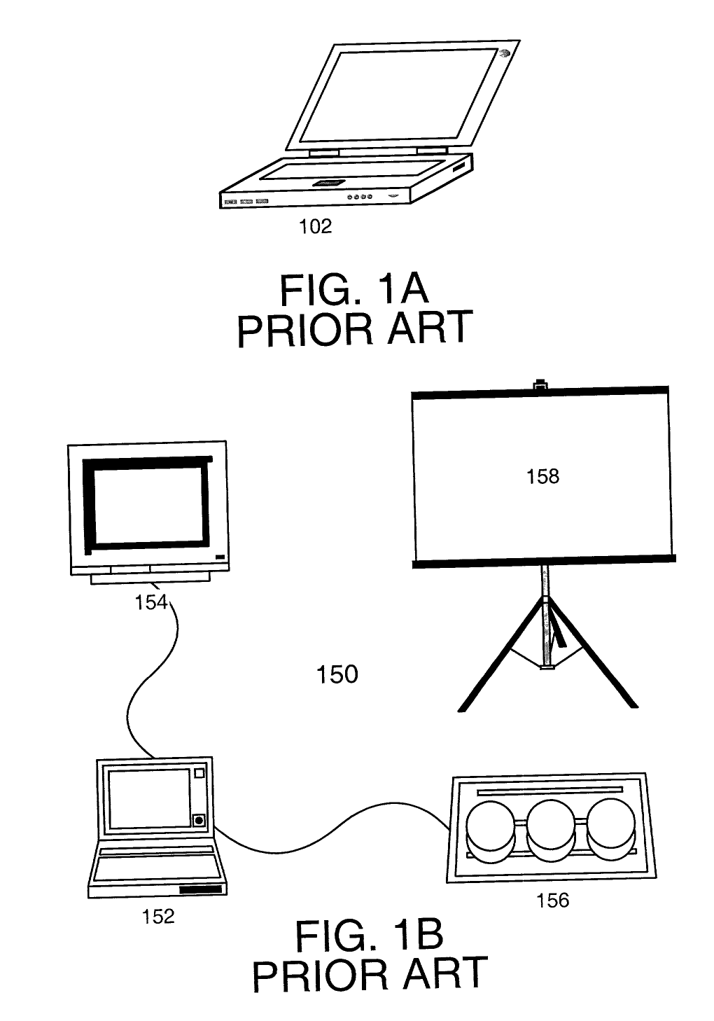

### DETAILED DESCRIPTION

A method for a mobile computer system with an integrated micro projection display is disclosed. The embodiments described herein are described in the context of a mobile computer system, but are not so limited. Although the following embodiments are described with reference to a mobile computer, other embodiments are applicable to other computers. The same techniques and teachings of the present invention can easily be applied to other types of circuits or systems that can benefit from a smaller form factor and lower costs.

In the following description, for purposes of explanation, numerous specific details are set forth in order to provide a thorough understanding of the present invention. One of ordinary skill in the art, however, will appreciate that these specific details are not necessary in order to practice the present invention. In other instances, well known electrical structures and circuits have not been set forth in particular detail in order to not necessarily obscure the present invention.

Mobile computers are being used in a variety of business and home applications. One of the major components in a notebook machine is the display screen. Embodiments of the present invention combine a portable computing device, such as a notebook computer, with an integrated micro projection display. Thus, the liquid crystal display (LCD) typically found on notebook computers can be replaced with an integrated projector. Such a projector provides a smaller, light, lower power, and cheaper alternative to the large, bulky, power consuming, and expensive glass display. For one embodiment, the projector can project an image of the computer graphics onto a small detachable screen about a foot from the unit. The micro projector of one embodiment employs an optical system similar to regular projectors, but smaller in size and light output. The optical system can thus be designed to fit inside a mobile platform. The micro projection system can be attached to the standard video output of the computer in place of the LCD screen in order to share graphics electronics and reduce costs. The LCD screen can be a significant portion of the price tag for a mobile computer. By deleting the LCD screen, the price of a mobile computer can drop by a great percentage. The micro projector is integrated with the base electronics of the computing device. The semiconductor devices of micro projection systems can also be cost competitive with existing LCDs. Such semiconductor image devices are small in size and can further scale with process technologies, driving manufacturing costs down. As the technology progresses, the size of viewable images that can be projected may be scaled upwards.

Projection technology decouples the size of the display device from the size of the image itself. Existing notebook form factors need to accommodate the size of the physical glass display screen. Embodiments in accordance with the present invention allow notebook computers to be built substantially smaller than the size of the projected image. Depending on the type of projector included in each particular implementation, the integrated micro projector may consume less power than a traditional backlit LCD screen of comparable viewing area. Furthermore, an integrated micro projector can also weigh much less than a glass LCD screen. Such differences become more pronounced as the size of the viewable area grows.

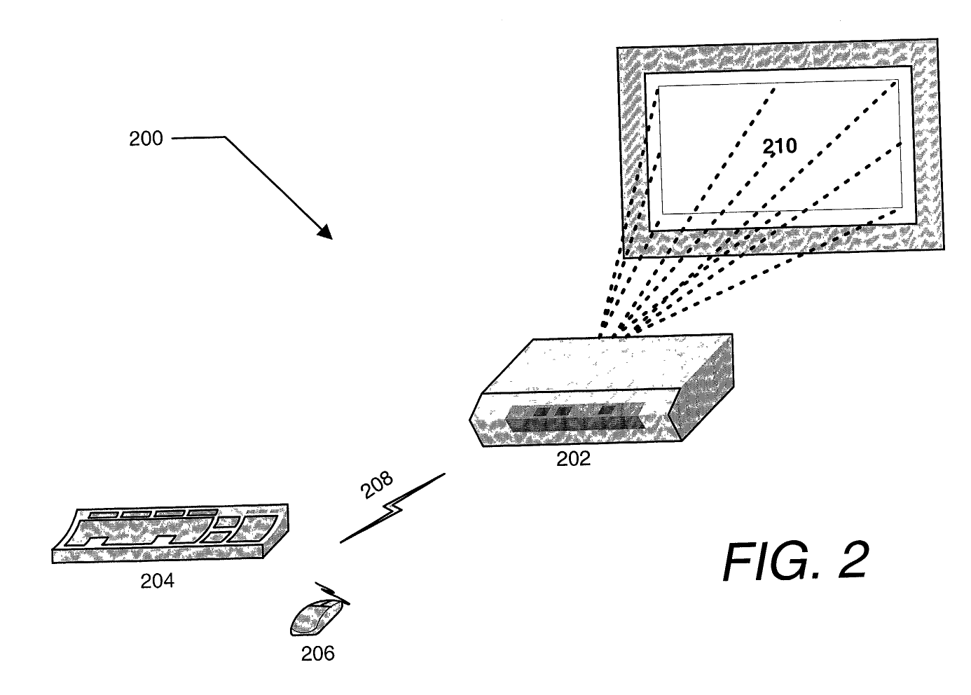

FIG. 2 is an illustration of a mobile computer with an integrated micro projection display in accordance with one embodiment of the present invention. The term mobile computer is in reference to generally portable computer systems such as notebook computers, laptop computers, sub-notebook computers, handheld computers, and palmtop computers, but is not limited as such. The system 200 shown in this example comprises of a mobile computing unit 202, wireless keyboard 204, wireless mouse 206, and portable projection screen 210. The mobile computing unit 202 of this embodiment has a wireless transceiver and micro projection unit incorporated into the computing module 202. The wireless transceiver is to communicate via wireless links 208 with the keyboard 204 and mouse 206.

The micro projection unit located in the mobile computing unit 202 is to project the graphical information that is typically displayed on monitors and LCD screens. In this case, the micro projector is to provide front projection of images, but other embodiments can also have rear projection. Technologies for such a micro projector can include various types of micro displays such as mirror devices, liquid crystal on semiconductor (LCOS) devices, and laser projection devices. An example LCOS device uses electricity to change light beams. When a light is shone on the silicon, the light is reflected through optics to form an image. The light source of one embodiment has enough power to provide an image approximately the same size as a regular notebook LCD screen, but still be low power.

The information is projected from the internal projector of the mobile computing unit 202 onto a passive screen 210. The projection screen 210 of this embodiment can be easily rolled or folded up and transported with the computing unit 202. The screen 210 can be temporarily mounted onto a wall or fixed onto a detachable stand. For another embodiment, the passive screen 210 is a springy, flexible type of screen that can be folded up. However, a projection screen may not be needed. The micro projector of an alternative embodiment can project onto a blank white space such as a conference room wall. This integrated micro projector allows a user to share the screen contents with others in small group settings because the projected image does not have the viewing angle limitations often found in LCD screens. The distribution of light for viewing can be better in a projection system. A user can vary the size and brightness of a projected image by simply moving the white screen 210 closer or further away from the micro projector in the computing unit 202.

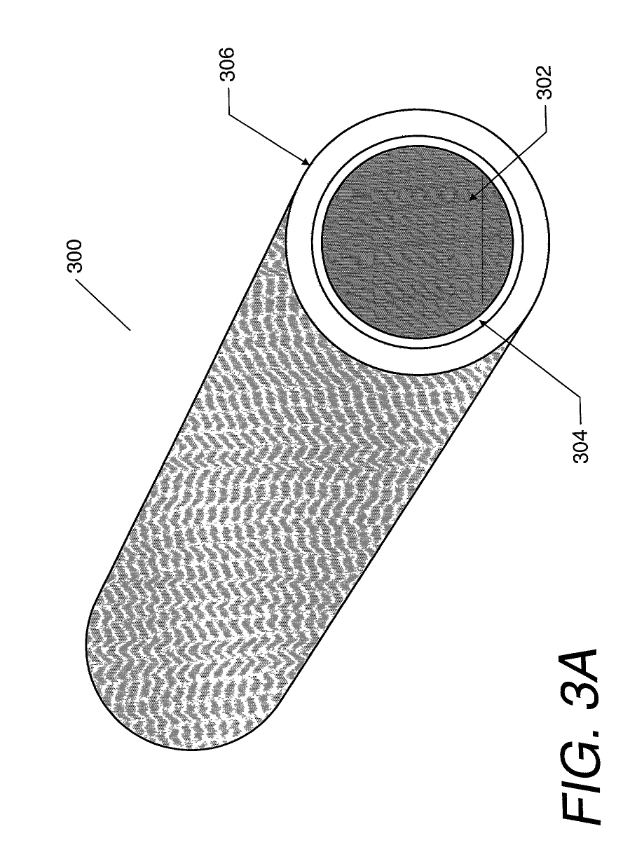

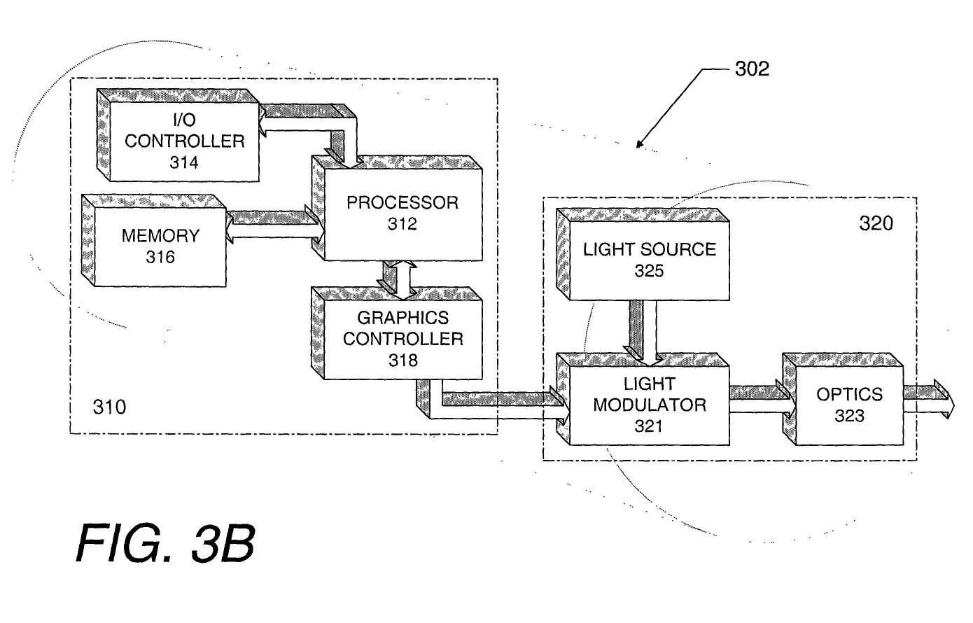

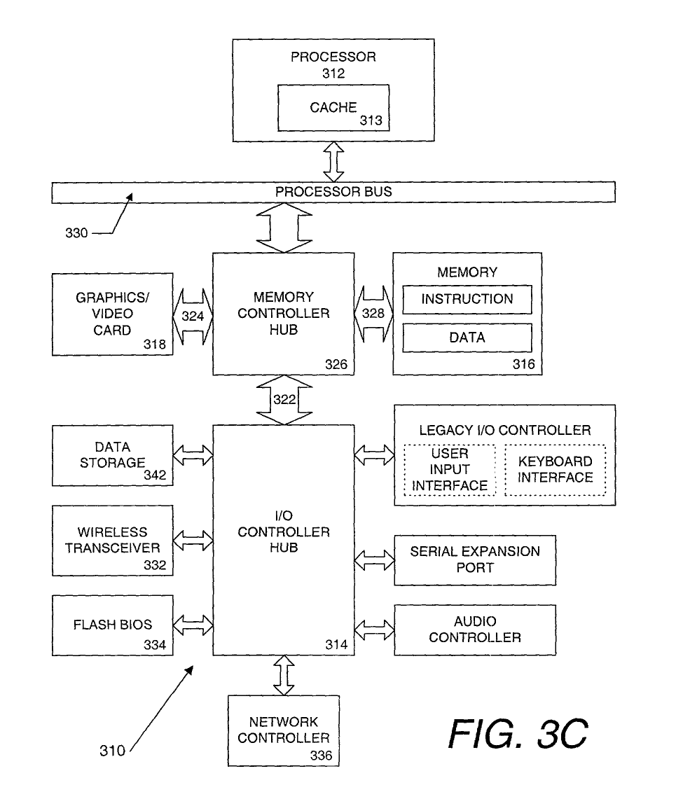

FIG. 3A is an illustration of another embodiment of a mobile computer having an incorporated micro projector. The computer 300 of this embodiment is shown in a closed configuration. During normal use, the computer 300 can be opened up and positioned. Because embodiments in accordance with the present invention are constrained with physical restrictions, computers can be designed into non-traditional form factors. For instance, almost all existing mobile computers are flat and rectangular in shape. These mobile computers have a clamshell configuration wherein the top leaf is a LCD screen and the bottom leaf is a keyboard. The driving forces behind this form factor are the size of the keyboard and the size of the size/type of display. For example, if a full size 101 key keyboard is included with the mobile computer, the surface area of the computer has to be large enough to hold all of the keys. Similarly, the dimensions of the screen generally extend to the very length and width dimensions of the computer case in order to maximize the viewable area. Thus, the size of mobile computers is constrained and cannot be reduced without making valuable concessions in the display screen dimensions or the keyboard size.

By including a micro projector in accordance with the present invention, embodiments of mobile computers can eliminate the built-in flat LCD display screen. The one to one relationship between the size of the computer case and the viewable image can be broken when the LCD screen is removed. The use of a wireless keyboard to receive user input further eliminates the physical constraints of the mobile computer. A foldable keyboard can also be used with such a mobile computer system. Thus embodiments of computer systems in accordance with the present invention can have different shapes and smaller sizes. For example, the mobile computer 300 of this FIG. 3A is designed with a round cylindrical shape. This mobile computer 300 comprises of a base unit 302, a screen 304 and a flexible keyboard/mouse 306. The base unit 302 includes a processor, micro projector, and a wireless module.

The incorporated micro projector provides the functionality of the traditional LCD display screen by projecting the display on a surface without the need for a rigid LCD display panel. The wireless module allows the use of wireless peripherals such as a wireless keyboard and mouse with the mobile computer 300. In the closed configuration, the screen 304 is wrapped around the base unit 302 and the flexible keyboard/mouse 306 are wrapped around the outer surface. During normal use, the mobile computer system 300 is opened and laid out. The keyboard/mouse 306 are removed from the system and unrolled to input data. The passive display screen 304 is unrolled from the base unit 302 and set into place. The base unit 302 is positioned to aim the built-in micro projector at the screen 304. As the mobile computer 300 operates, the micro projector projects graphics and video to the display screen 304. The ability to design mobile computers with alternative form factors allows for the inclusion of a full size keyboard and a large viewable display with a mobile system while reducing the overall size and dimensions of the computer itself.

Embodiments of mobile computing systems designed in accordance with the present invention can benefit from reductions in size, weight, and power consumption requirements of current portable computers. LCD screens can consume an enormous amount of power, especially if the brightness/contrast is turned up to maximum settings while the system is operating on battery power. The micro projection devices incorporated in embodiments of the present invention are small, low power projection devices. Because these micro projectors are small and low power, the overall mobile computer itself can also be designed smaller, lighter, and with improved battery life. Alternative battery packs having greater efficiency can be used in these mobile computers as the form factors develop. Present mobile machines usually have some type of flat or skinny battery due to the shape of the computer. These flat batteries can be inefficient in holding large amounts of charge. With the advent of mobile computers that are free from the physical restrictions of the glass screen, batteries of other shapes and dimensions can be used with these mobile systems. Furthermore, different form factors of the computer system can allow for larger heat sinks and other power dissipation schemes not presently available to thin mobile machines.

FIG. 3B is a block diagram of the innards for the base unit 302 of FIG. 3A. The base unit 302 in this embodiment comprises of two portions: a computing subsystem 310 and an optical subsystem 320. Both subsystems are housed together in the base unit. The computing subsystem 310 is to perform the conventional functions of a computer. The computing subsystem 310 comprises a processor 312. Coupled to the processor is an I/O controller 314 to interface with peripheral I/O devices. Memory 316 to store data and instructions is also coupled to processor 312. A graphics controller 318 to handle the graphical data is coupled to the processor 312. The computing subsystem 310 is coupled to the optical subsystem 320. A light source 325 in the optical subsystem 320 is coupled to a light modulator 321.

The graphics controller 318 of the computing subsystem 310 is also coupled to the light modulator 321. In one embodiment, the graphics controller 318 has its own frame buffer for storing the display data. A frame buffer or other storage can also reside within the optical subsystem 320. The light source 325 provides light to the light modulator 321, which is to modulate the rays of light in response to commands and data from the graphics controller 318. For one embodiment, the light source 325 is a low power light. The optics 323 is to receive modulated light from the light modulator 321. The optics 323 of the optical subsystem 320 is to project the modulated light to a display screen for viewing. For alternative embodiments, other types of light transducers can be used in the optical subsystem 320.

Referring now to FIG. 3C, an exemplary computing subsystem 310 is shown. Subsystem 310 is representative of processing systems based on the PENTIUM® III, PENTIUM® 4, Itanium™, or StrongARM™ microprocessors available from Intel Corporation of Santa Clara, Calif., although other systems (including PCs having other microprocessors, engineering workstations, set-top boxes and the like) may also be used. In one embodiment, sample subsystem 310 may execute a version of the WINDOWS™ operating system available from Microsoft Corporation of Redmond, Washington, although other operating systems and graphical user interfaces, for example, may also be used. Thus, the present invention is not limited to any specific combination of hardware circuitry and software.

FIG. 3C is a block diagram of the computing subsystem 310 in the base unit 302 of one embodiment of a mobile computer system 300 having a micro projection display in accordance with the present invention. The processor 312 includes an internal cache memory 313. The present embodiment is described in the context of a single processor mobile system, but alternative embodiments can be included in a multiprocessor system. Subsystem 310 is an example of a hub architecture. The computing subsystem 310 includes a processor 312 to process data signals. The processor 312 can be a complex instruction set computer (CISC) microprocessor, a reduced instruction set computing (RISC) microprocessor, a very long instruction word (VLIW) microprocessor, a processor implementing a combination of instruction sets, or other processing device, such as a digital signal processor, for example. The processor 312 is coupled to a processor bus 330 that transmits data signals between the processor 312 and other components in the system 310. The elements of subsystem 310 perform their conventional functions well known in the art.

Computing subsystem 310 includes a memory 316. Memory 316 can be a dynamic random access memory (DRAM) device, a static random access memory (SRAM) device, flash memory device, or other memory device. Memory 316 can store instructions and/or data represented by data signals that can be executed by the processors 312. A cache memory 313 can reside inside the processor 312 to store data signals stored in memory 316. Alternatively, in another embodiment, the cache memory can reside external to the processor 312.

A system logic chip 326 is coupled to the processor bus 330 and memory 316. The system logic chip 326 in the illustrated embodiment is a memory controller hub (MCH). The processor 312 can communicate to the MCH 326 via a processor bus 330. The MCH 326 provides a high bandwidth memory path 328 to memory 316 for instruction and data storage and for storage of graphics commands, data and textures. The MCH 326 is to direct data signals between the processor 312, memory 316, and other components in the subsystem 310 and to bridge the data signals between processor bus 330, memory 316, and system I/O 314. In some embodiments, the system logic chip 326 provides a graphics port for coupling to a graphics controller 318. The graphics card 318 is coupled to the MCH 334 through an Accelerated Graphics Port (AGP) interconnect 324.

Subsystem 310 uses a proprietary hub interface bus 322 to couple the MCH 326 to the I/O controller hub (ICH) 314. The ICH 314 provides direct connections to some I/0 devices. Some examples are the audio controller, firmware hub (flash BIOS) 334, data storage 342, legacy I/O controller containing user input and keyboard interfaces, a serial expansion port such as Universal Serial Bus (USB), and a network controller 336. The data storage device 342 can comprise a hard disk drive, a floppy disk drive, a CD-ROM device, a flash memory device, or other mass storage device.

For the embodiment of a computing subsystem 310 in FIG. 3C, a wireless transceiver 332 is also coupled to the ICH 314. The wireless transceiver 332 is capable of receiving and transmitting wireless signals to and from the system 300. Control of this transceiver 332 resides with software located in the transceiver logic and memory 316. Processor 312 can execute instructions from memory 316 that cause the processor 312 to send data to and request from the wireless transceiver 332. Furthermore, the wireless transceiver 332 can interact with other system components including the audio controller, network controller 336, and I/O controllers as needed when the system is in control of external wireless I/O devices. For example, the keyboard controller can request keyboard input data from a wireless keyboard via the wireless transceiver 332 The operating system and device driver software can also interface with the wireless transceiver 332. The wireless transceiver enables the computer system 300 to communicate with other computers and devices that have wireless capability. For one embodiment, the wireless transceiver conforms to the Bluetooth communication protocol.

For another embodiment of a system, one implementation of a mobile computer with can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

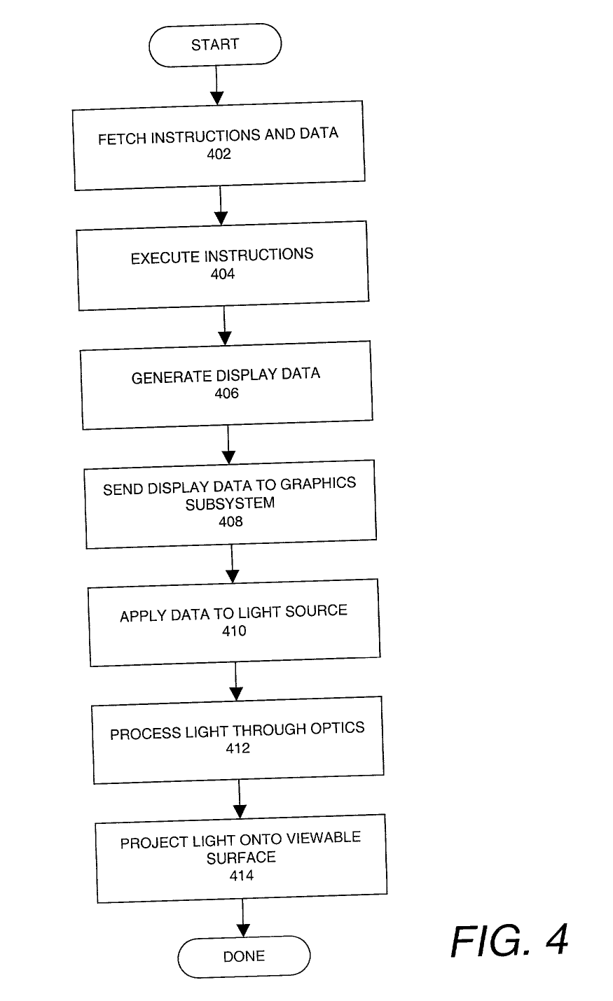

FIG. 4 is a flow chart showing one embodiment of a method in accordance with the present invention for a mobile computer with an integrated micro projection display. This example generally describes the operation of a mobile computer and integrated projector of one embodiment. At block 402, instructions and data are fetched for execution in a computing subsystem. The instructions are executed at block 404 by a processor in the mobile computer. The processor also generates display data at step 406. This display data is sent at block 408 to an optical subsystem. At block 410, the graphics data is applied to the light source through a light projection device. The manipulated light beams are processed through optics at block 412. At block 414, the light is projected from the optics onto a viewing surface.

The examples above have been described in the context of a single processor. In a multiprocessor system, the method can be performed concurrently in each processor.

In the foregoing specification, the invention has been described with reference to specific exemplary embodiments thereof. It will, however, be evident that various modifications and changes may be made thereof without departing from the broader spirit and scope of the invention as set forth in the appended claims. The specification and drawings are, accordingly, to be regarded in an illustrative rather than a restrictive sense.

What is claimed is:

1. An apparatus comprising:
a computing subsystem to process data and execute program instructions; and
an optical subsystem coupled to said computing subsystem, said optical subsystem integrated into said apparatus to project an image for said computing subsystem onto a viewing surface.

2. The apparatus of claim 1 further wherein said computing subsystem and said optical subsystem are housed together in a base unit.

3. The apparatus of claim 2 wherein said viewing surface comprises a portable, passive screen having a white area to display said image.

4. The apparatus of claim 3 further comprising a first wireless input device coupled to said computing subsystem via a first wireless communication link, said first wireless input device to receive user input and to send said user input to said computing subsystem via said first wireless communication link.

5. The apparatus of claim 4 wherein said first wireless input device is a keyboard.

6. The apparatus of claim 5 further comprising a second wireless input device coupled to said computing subsystem via a second wireless communication link, wherein said wireless input device is a mouse.

7. The apparatus of claim 6 wherein said optical subsystem comprises an integrated micro projection device.

8. The apparatus of claim 7 wherein said micro projection device comprises a liquid crystal on semiconductor (LCOS) device to manipulate light in response to graphical data.

9. The apparatus of claim 8 further comprising optics to receive manipulated light from said LCOS device, said optics to form said manipulated light into said image.

10. The apparatus of claim 9 further comprising a wireless transceiver coupled to said computing subsystem, said wireless transceiver to form said first wireless communication link between said computing subsystem and said first wireless input devices, and to form said second wireless communication link between said computing subsystem and said second wireless input device.

11. The apparatus of claim 10 wherein said apparatus comprises a mobile computer system.

12. A mobile computer comprising:
a memory to store instructions;
a processor coupled to said memory, said processor to execute said instructions;
a graphics controller coupled to said processor, said graphics controller to receive commands from said processor and to generate display data;
a light modulator coupled to said graphics controller, to receive said display data and to modulate light based on said display data; and
an optic coupled to said light modulator, said optic to receive modulated light from said light modulator, said optic to create an image on a surface.

13. The mobile computer of claim 12 wherein said light modulator comprises a silicon based semiconductor device to reflect light through said optic.

14. The mobile computer of claim 13 wherein said silicon based semiconductor device comprises a liquid crystal on semiconductor (LCOS) device.

15. The mobile computer of claim 14 wherein said mobile computer lacks a liquid crystal display (LCD) screen.

16. The mobile computer of claim 15 wherein said surface comprises a passive display screen to display said image.

17. The mobile computer of claim 16 further comprising a wireless input device coupled to said processor, said wireless input device to receive user input, and to send said user input to said processor via a wireless communication link.

18. A method comprising:
executing program instructions on a mobile computer;
generating display data based on results of said instructions;
propagating said display data to a micro projection system that is integrated within said mobile computer;
modulating light beams in response to said display data; and
projecting modulated light beams though optics.

19. The method of claim 18 further comprising displaying an image resulting from said modulated light beams onto a portable, passive display screen.

20. The method of claim 19 further comprising storing said display data in a frame buffer within said micro projection system integrated within said mobile computer.

21. The method of claim 20 further comprising receiving user input from a wireless input device via a wireless communication link.
